(19) United States
(12) Patent Application Publication
(10) Pub. No.: US 2016/0292717 A1
(43) Pub. Date: Oct. 6, 2016

(54) ADJUSTING CONTENT ITEM SPECIFIC BID AMOUNTS TO BIAS SELECTION OF CONTENT ITEMS FROM AN AD CAMPAIGN

(71) Applicant: Facebook, Inc., Menlo Park, CA (US)

(72) Inventors: Anand Sumatilal Bhalgat, Mountain View, CA (US); Chinmay Deepak Karande, Mountain View, CA (US); Tanmoy Chakraborty, San Mateo, CA (US)

(21) Appl. No.: 14/678,862

(22) Filed: Apr. 3, 2015

(51) Int. Cl. G06Q 30/02; G06Q 50/00

(52) U.S. Cl. CPC G06Q 30/0246; G06Q 30/0249; G06Q 30/0275; G06Q 50/01

(57) ABSTRACT

For ad campaigns including multiple advertisement (“ad”) requests each including an ad creative, which are automatically selected, a social networking system, or any other suitable online system, may bias selection of ad requests from an ad campaign towards early-selected ad requests with positive user interactions, limiting the number of ad requests selected from the ad campaign. To increase the likelihood of various advertisements in an ad campaign being evaluated for presentation to users, the social networking system modifies bid amounts associated with advertisements in the ad campaign using advertisement-specific bid adjustments based on interactions with the ad requests. Based on the modified bid amounts, the social networking system selects ad requests from the ad campaign to evaluate for presentation to a user.

### BACKGROUND

This disclosure relates generally to presenting content via social networking systems, and more specifically to adjusting bid amounts of content items when selecting content for presentation to social networking system users.

A social networking system, or other suitable online system, allows its users to connect to and communicate with other social networking system users. Users may create profiles on a social networking system that are tied to their identities and include information about the users, such as interests and demographic information. The users may be individuals or entities such as corporations or charities. Because of the increasing popularity of social networking systems and the increasing amount of user-specific information maintained by social networking systems, a social networking system provides an ideal forum for entities to increase awareness about products or services by presenting content items to social networking system users.

Presenting content items to social networking system users allows an entity to gain public attention for products or services or to persuade online users to take an action regarding the entity's products or services. Additionally, many social networking systems generate revenue by displaying certain content items to their users. Frequently, social networking systems charge entities for each presentation of certain types of content items to a social networking system user (e.g., each “impression” of the advertisement) or for each interaction with certain types of content items by a social networking system user.

Conventionally, an entity provides a campaign to a social networking system. The campaign often includes multiple content items each presenting different content to social networking system users. A social networking system selects a content item from a campaign based on performance or expected performance of the content item when presented to users of the social networking system (e.g., prior interaction or expected interaction by social networking system users with the content items). However, this often causes a social networking system to continually select content items with a threshold performance, which may prevent selection of other content items in a campaign that have received a limited amount of user interaction.

### SUMMARY

A social networking system receives an advertisement (“ad”) campaign including a set of advertisement requests (“ad requests”). Each ad request includes one or more ad creatives, or “advertisement,” that identifies content presented to a social networking system user when the ad request is presented. Additionally, the ad campaign may include information describing presentation of ad creatives to users of the social networking system, such as a budget specifying an amount of compensation received by the social networking system for presenting ad requests in the ad campaign. In some embodiments, an objective associated with presenting ad requests is also included in the ad campaign and specifies a goal of the advertiser for presentation of ad requests in the ad campaign to social networking system users. One or more ad requests in the set of ad requests may have been presented to less than a threshold number or percentage of social networking system users; for example, ad requests newly included in the ad campaign have not been presented to the threshold number or threshold percentage of social networking system users.

When the social networking system identifies an opportunity to present advertisements to a user of the social networking system, the social networking system identifies ad requests from the set of ad requests in the ad campaign eligible for presentation to the user and determines bid amounts for the ad requests from the ad campaign eligible for presentation to the user. For example, the social networking system identifies a plurality of ad requests from the ad campaign that include at least a threshold number of targeting criteria satisfied by characteristics of the user. In some embodiments, bid amounts are included in ad requests in the ad campaign, and the social networking system determines bid amounts included in the ad requests eligible for presentation to the user. Alternatively, a budget is associated with the ad campaign specifying a total amount of compensation for the social networking system to receive for presenting ad requests from the ad campaign instead of bid amounts associated with individual ad requests in the ad campaign. Based on the budget and an expected amount of interaction by social networking system users with various ad requests eligible for presentation to the user, and an objective included in the ad campaign, the social networking system determines bid amounts associated with ad requests eligible for presentation to the user in some embodiments.

The social networking system determines bid adjustments for each of the ad requests eligible for presentation to the user. Each bid adjustment is specific to an ad request from the ad campaign that is eligible for presentation to the user. A bid adjustment associated with an ad request is determined based on information describing engagement with the advertisement in the ad request by users of the social networking system previously presented with an advertisement in the ad request. Example information describing engagement with an advertisement form an ad request by users who were presented with the advertisement includes: a number of impressions associated with the advertisement, a number of a specific type of interactions with the advertisement (e.g., a number of times the advertisement was clicked on), and an interaction with an object associated with the advertisement. For example, the bid adjustment is an amount by which a bid amount associated with an ad request is modified that is based at least in part on an amount of engagement by users who were presented with the advertisement in the ad request. In one embodiment, the bid adjustment of an ad request decreases as the amount of engagement with the advertisement in the ad request increases.

Based at least in part on the bid adjustments, the social networking system adjusts the bid amounts associated with ad requests eligible for presentation to the user. A bid amount associated with an ad request is adjusted by the bid adjustment corresponding to the ad request. For example, the bid adjustment associated with an ad request is a value that is added or subtracted to the bid amount associated with the ad request to generate an adjusted bid amount associated with the ad request. In various embodiments, the bid amount associated with an ad request may be modified by the bid amount using any suitable method (e.g., the bid amount may be multiplied by the bid adjustment, the bid amount may be divided by the bid adjustment, etc.).

The social networking system selects one or more ad requests from the ad campaign for inclusion in a selection process based on the adjusted bid amounts associated with the ad requests in the ad campaign. For example, the social networking system ranks ad requests from the ad campaign based on their adjusted bid amounts and selects ad requests from the ad campaign having at least a threshold position in the ranking. As another example, the social networking system selects ad requests from the ad campaign having at least a threshold adjusted bid amount. If an ad request from the ad campaign is selected for presentation to the user by the selection process, the social networking system communicates the ad request to a client device for presentation to the user. A bid adjustment associated with the ad request from the ad campaign presented to the user may be modified when the ad request is presented to the user or when the user interacts with the ad request (e.g., performs a specific type of interaction with the ad request, performs a specific type of interaction with an object associated with the ad request). In some embodiments, the bid adjustment associated with an ad request from the ad campaign including an advertisement presented to the user is decreased if the user not does interact with the presented advertisement within a threshold time interval, if the user hides the advertisement from view, or if an indication of the user performing any suitable action indicating a lack of preference for the advertisement is received by the social networking system.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flowchart of a method for selecting advertisement requests from an ad campaign for inclusion in a selection process for presentation to a social networking system user based on bid adjustments and bid amounts associated with the advertisement requests, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

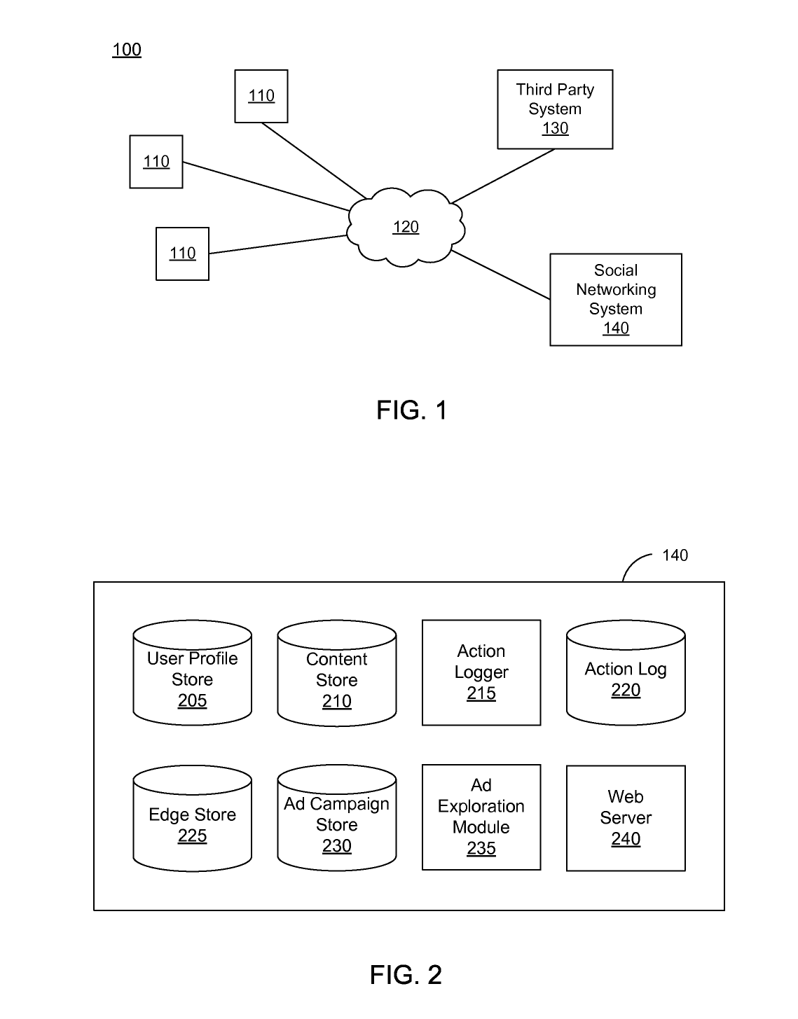

FIG. 1 is a block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

FIG. 2 is a block diagram of an architecture of the social networking system 140. The social networking system 140 shown in FIG. 2 includes a user profile store 205, a content store 210, an action logger 215, an action log 220, an edge store 225, an advertisement (“ad”) campaign store 230, an ad exploration module 235, and a web server 240. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture. In various embodiments, the functionality described below may be adapted for use online systems other than a social networking system 140.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system 140 using a brand page associated with the entity's user profile. Other users of the social networking system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system 140, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user by the social networking system 140.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the social networking system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or in another user in the social networking system 140 based on the actions performed by the user. A user's affinity may be computed by the social networking system 140 over time to approximate the user's interest in an object, in a topic, or in another user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement campaigns (“ad campaigns”) are included in the ad campaign store 230. An ad campaign includes a plurality of advertisement requests (“ad requests”) received from an advertiser for presentation to users of the social networking system 140. Each ad request includes an advertisement creative, also referred to as an advertisement or an ad creative, which is content presented to a social networking system user. Examples of an ad creative include text data, image data, audio data, video data, or any other suitable data. An ad request may also associate a destination address with an ad creative to specify a source of content presented to a user who accesses the ad creative when it is presented. For example, the destination address identifies a landing page including content that is presented to the user when the user accesses the ad creative.

Additionally, ad requests in an ad campaign may be associated with a bid amount provided by the advertiser that provided the ad campaign. A bid amount associated with an ad request specifies an amount of compensation an advertiser provides the social networking system 140 for presenting the ad creative in the ad request, for a user interacting with the ad creative in the ad request, or for another suitable interaction with the ad creative by a user. In some embodiments, the advertiser specifies bid amounts for a subset of the ad requests in the ad campaign and a budget for the ad campaign specifying a maximum amount the advertiser will provide to the social networking system 140 for presenting ad requests in the ad campaign and the social networking system 140 determines bid amounts for other ad requests in the ad campaign that are not associated with bid amounts. Alternatively, the advertiser specifies the budget for the ad campaign and a duration for the ad campaign that specifies a time interval during which ad requests from the ad campaign are presented and the social networking system 140 determines bid amounts associated with ad requests in the ad campaign based on the budget and the duration.

Additionally, ad requests in an ad campaign may be associated with one or more targeting criteria. In some embodiments, targeting criteria may be associated with the ad campaign in its entirety, so multiple advertisements in the ad campaign are associated with the targeting criteria. Additionally, an advertiser may specify targeting criteria associated with various individual ad requests in the ad campaign to associate different targeting criteria with various ad requests. Targeting criteria associated with an ad request specify one or more characteristics of users eligible to be presented with an ad creative included in the ad request. Associating different targeting criteria with different ad requests in the ad campaign allows an advertiser to tailor presentation of ad creatives to users having specific characteristics, allowing different ad creatives to be presented to users with different characteristics. For example, targeting criteria specify demographic information, connections, or actions associated with a user. In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third party system 130, or any other suitable action. Including actions in targeting criteria allows advertisers to further refine users eligible to be presented with ad requests from an ad campaign. As another example, targeting criteria identifies users having a connection to another user or object or having a particular type of connection to another user or object.

Additionally, the ad campaign may include an objective specifying a goal of the advertiser for presentation of ad requests in the ad campaign to social networking system users. For example, the objective identifies a type of interaction with ad requests included in the ad campaign or with one or more objects associated with ad requests in the ad campaign by social networking system users presented with an ad creative included in an ad request from the ad campaign. Examples of objectives include: social networking system users accessing a presented ad creative (e.g., clicking or otherwise accessing the advertisement), social networking system users installing an application associated with a presented ad request, social networking system users expressing a preference for a page associated with an ad request (i.e., “liking” the page), social networking system users viewing a page associated with the ad campaign, or any other suitable action by social networking system users. In one embodiment, the objective is selected from a set of objectives maintained by the social networking system 140.

Additional information may be included in the ad campaign. For example, the ad campaign includes a budget that specifies a total amount of compensation an advertiser provides the social networking system 140 for presenting ad requests included in the ad campaign. The budget may be allocated for the ad campaign as a whole or per ad request. In addition, the advertiser may specify instructions for allocating the budget among the ad requests in the ad campaign. For example, the instructions specify modification of a bid amount associated with an ad request included in the ad campaign based on an amount of the budget that remains and characteristics of the ad request (e.g., a number of impressions of the ad request that have occurred, a number of a specific type of interaction with the ad request that have occurred). The instructions may also include other suitable information describing allocation of budget among ad requests included in the ad campaign.

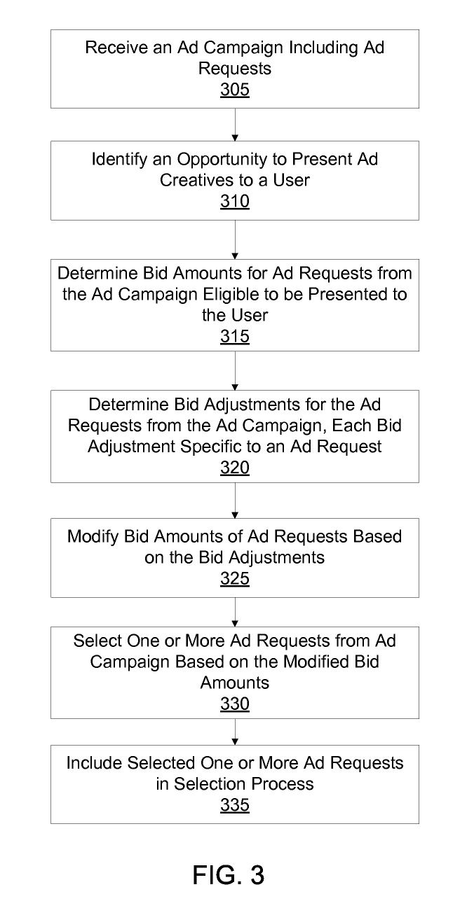

When the social networking system 140 receives an ad campaign including various ad requests, the ad exploration module 235 determines bid adjustments for one or more of a set of the ad requests. The ad exploration module 235 modifies bid amounts of ad requests in the set based on the bid adjustments corresponding to the various ad requests and selects one or more ad requests from the set based at least in part on the adjusted bid amounts of the ad requests in the set. In various embodiments, selected ad requests from the ad campaign are included in one or more selection processes with other content items (e.g., ad requests from other ad campaigns, stories describing interactions performed by social networking system users, messages from a social networking system user to another social networking system user, etc.) that select content items for presentation to a user. A selection process may account for bid amounts, such as the adjusted bid amounts associated with ad requests selected from the ad campaign, when selecting content items for presentation to a user. For example, the ad exploration module 235 identifies ad requests from an ad campaign associated with targeting criteria satisfied by one or more characteristics of a user and determines bid adjustments for bid amounts associated with the identified advertisements. In some embodiments, the ad exploration module 235 determines bid amounts associated with the identified ad requests based on a budget associated with the ad campaign as well as information describing prior engagement with ad requests in the ad campaign in addition to determining bid adjustments associated with the identified ad requests. Ad requests from the ad campaign may be identified based on information in the user's user profile stored in the user profile store 205, actions in the action log 220 associated with the user, connections in the edge store 225 associated with the user, or other information associated with the user. As further described below in conjunction with FIG. 3, the ad exploration module 235 selects one or more of the identified ad requests from the ad campaign by determining bid adjustments for each of the identified ad requests, modifying bid amounts associated with the identified ad requests based on the bid adjustments, and selecting one or more of the identified ad requests for inclusion in a selection process based at least in part on the modified bid amounts.

The web server 240 links the social networking system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the social networking system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

Selecting Ad Requests from an Ad Campaign by Modifying Ad Request Bid Amounts

FIG. 3 is a flowchart of one embodiment of a method for selecting ad requests from an ad campaign to evaluate for presentation to a user of the social networking system 140 based on bid adjustments associated with the ad requests. In various embodiments, the steps described in conjunction with FIG. 3 may be performed in different orders. Additionally, in some embodiments, the method may include different and/or additional steps than those shown in FIG. 3.

The social networking system 140 receives 305 an ad campaign from an advertiser that includes various ad requests, where a set of the ad requests are associated with less than a threshold amount of interaction by social networking system users. For example, an ad request in the set of advertisements was presented to less than a threshold number of social networking system users or received less than a threshold number of interactions (or less than a threshold number of a specific type of interaction) from social networking system users presented with ad content from the ad request. As described above in conjunction with FIG. 2, the ad campaign may include an objective, a budget, instructions for allocating the budget among ad requests in the ad campaign, or other suitable information. Ad requests included in the ad campaign, including ad requests in the set of advertisements, include one or more ad creatives specifying content for presentation to social networking system users and may be associated with one or more targeting criteria or other suitable information. For example, the received ad campaign includes an ad request including a plurality of ad creatives, where a set of the ad creatives are associated with less than a threshold amount of interaction by social networking system users. The ad creative may also include instruction for allocating a budget, or a portion of the budget, among ad creatives in the ad request.

The social networking system 140 identifies 310 an opportunity to present one or more ad requests to a user of the social networking system 140 via a client device 110. For example, the social networking system 140 receives a request to present one or more ad creatives from a client device 110 associated with a social networking system user. In various embodiments, the client device 110 communicates the request to present ad creatives from one or more ad requests to the social networking system 140 when the user views or interacts with at least a threshold number of ad creatives via the client device 110, when the client device 110 receives a specific type of interaction from a user, when a threshold number of content items are presented to the user via the client device 110, or at least a threshold amount of time lapses between a current time and a time when the user was presented with an additional ad creative. In some embodiments, information identifying 310 the opportunity to present one or more ad requests includes information describing the user to be presented with the advertisement (e.g., a user identifier or other information describing the user) or information describing the context in which an ad creative from an ad request is to be presented (e.g., a type of the client device 110, additional content presented by the client device 110 along with the advertisement, etc.). Alternatively, the opportunity to present one or more ad requests is identified 310 by the social networking system 140 accessing actions from the action log 220 associated with the user, receiving a request to log into the social networking system 140 from the user, or any other suitable indication of availability. An opportunity may also be identified 310 when a number of ad campaigns in the ad campaign store 230 exceeds a threshold number of ad campaigns or a number of ad requests in the ad campaign store 230 exceeds a threshold number of ad requests.

When the opportunity to present an ad request to the user is identified 310, the social networking system 140 identifies ad requests from the ad campaign eligible for presentation to the user. For example, the social networking system 140 identifies ad requests associated with at least a threshold number of targeting criteria satisfied by characteristics of the user. The identified ad requests include ad requests from the set of ad requests associated with less than the threshold amount of user interaction. In one embodiment, an ad request from the ad campaign that is eligible for presentation to the user is identified if the ad request has not previously been presented to at least a threshold number of social networking system users or has not received at least a threshold number of interactions from social networking system users. Additional information may also be used to identify ad requests eligible for presentation to the user. For example, information associated with the ad campaign including the ad requests or other suitable information associated with individual ad requests, with the ad campaign, or with the advertiser, such as described above in conjunction with FIG. 2, may be used to identify ad requests eligible for presentation to the user. In another embodiment, the ad requests eligible for presentation to the user are randomly identified from the ad campaign. For example, an ad request that has previously been presented to less than a threshold number of social networking system users is identified, such as an ad request that has not previously been presented to at least one social networking system user. In one embodiment, ad requests in the set of advertisements associated with one or more targeting criteria satisfied by the user and that have not been previously presented to social networking system users or that have been presented to less than a threshold number of social networking system users are identified.

Bid amounts associated with each of the identified ad requests are determined 315 by the social networking system 140. The identified ad requests may be each be associated with bid amounts in some embodiments, so the social networking system 140 determines 315 the bid amounts associated with each of the identified ad requests. In some embodiments, the ad campaign is associated with a budget, an objective, and instructions for allocating the budget among ad requests included in the ad campaign, as described above in conjunction with FIG. 2. The social networking system 140 determines 315 bid amounts for the identified ad requests based on prior interaction between users and ad requests in the ad campaign, a budget used or a budget remaining associated with the ad campaign, and the instructions for allocation the budget among the ad requests in the ad campaign. For example, the social networking system 140 determines a pacing multiplier for the ad campaign based on prior interactions between the social networking system users and ad requests from the ad campaign and an objective associated with the ad campaign, the pacing multiplier is then used to determine 315 bid amounts for one or more ad requests in the ad campaign. For example, if the ad campaign is associated with an objective specifying a number of impressions, a pacing multiplier is used to determine 315 bid amounts associated with ad requests in the ad campaign to spend a budget associated with the ad campaign so the number of impressions specified in the objective occurs over a specified time interval. Other interactions may be specified by the objective, with the pacing multiplier used to modify the bid amount of ad requests in the ad campaign to satisfy the objective over a specified time interval. The time interval for satisfying an objective may be associated with the ad campaign by an advertiser. Budget-based advertisement bidding using pacing multipliers is further described in U.S. patent application Ser. No. 13/294,094, filed on Nov. 10, 2011, which is hereby incorporated by reference in its entirety.

Various types of interactions with ad request in the ad campaign may be used by the social networking system 140 to determine the pacing multiplier. In some embodiments, the social networking system 140 determines an expected amount of interaction with an ad request, such as an expected click through rate of the ad request, which is a prediction of how often a user will interact with the ad request. For example, the expected click through rate is a probability that a user will accesses an ad request (e.g., a probability the user clicks on the ad request). Accordingly, a larger expected amount or interaction with an ad requests indicates the ad request indicates a larger likelihood of users interacting with the ad request if it is presented. An expected amount of interaction with an ad request may be determined based on prior interactions with social networking system users with other previously presented ad requests associated with an advertiser providing the ad requests or prior interactions by social networking system users with previously presented ad requests having ad creatives with at least a threshold number of similar characteristics as the ad creatives. For example, the expected amount of interaction with an ad request is an average of, a weighted average of, or any other suitable combination of expected amounts of interaction with other ad requests in the ad campaign or other ad requests having at least a threshold number or percentage of characteristics matching characteristics of the ad request.

The cost per interaction of an ad request may be associated with the ad request or with the ad campaign including the ad request and specifies an amount of compensation the social networking system 140 receives from an advertiser associated with the ad campaign when a type of interaction with the ad request (e.g., clicking on the presented ad creative) occurs. In some embodiments, the social networking system 140 determines a cost per interaction of an ad request based on costs per interaction associated with other ad requests in an ad campaign including the ad request, costs per interaction of other ad requests associated with same advertiser as the ad request, costs per interaction of other ad requests including ad creatives having a least a threshold number or percentage of characteristics matching characteristics of an ad creative included in the ad request, or based on any other suitable information. For example, the cost per interaction of an ad request is an average of, a weighted average of, or any other suitable combination of the costs per interaction associated with other ad requests having characteristics matching or similar to characteristics of the ad request.

In some embodiments, the social networking system 140 determines 315 a bid amount associated with an ad request, A, eligible for presentation to the user based on a pacing multiplier, an expected amount of interaction with the ad request, and the cost per interaction associated with the ad request as follows:

bid(A)=λ·ECTR(A)·CPC (1),

Where bid(A) is the bid amount for the ad request A, λ is the pacing multiplier, ECTR(A) is the expected amount of interaction of ad request A, and CPC is the cost per interaction for ad request A. In other embodiments, the bid amount for ad request A may also be determined by modifying one or more of the pacing multiplier, the expected amount of interaction, or the cost per interaction by a constant or a weight.

Alternatively, the social networking system 140 determines 315 a bid amount associated with an ad request eligible for presentation to the user by determining 315 a bid amount for the ad request as a maximum bid amount from the bid amounts associated with ad requests in the ad campaign including the ad request. For example, bid amounts associated with each ad request in the ad campaign including the ad request are ranked, with the maximum bid amount determined from the ranking. The budget associated with the ad campaign may also be used to determine the maximum bid amount from the ad campaign. For example, a remaining budget associated with the ad campaign is determined based on a difference between the amount of compensation received by the social networking system 140 for presenting ad requests from the ad campaign and the budget associated with the ad campaign. If the maximum bid amount associated with an ad request in the ad campaign exceeds the remaining budget, an alternative maximum bid amount that is less than or equal to the remaining budget is determined.

The social networking system 140 determines 320 bid adjustments for ad requests eligible for presentation to the user, where different bid adjustments are specified to different ad requests. Hence, bid adjustments may be referred to herein as “ad request-specific bid adjustments.” In some embodiments, the bid adjustments are determined 320 for ad requests eligible for presentation to the user and associated with less than a threshold amount of interaction by users. An ad request-specific bid adjustment associated with an ad request is determined 320 based on information describing engagement with the ad request by users of the social networking system 140 such as a number of impressions associated with the ad request, a number of a specific type of interactions (e.g., clicks) associated with the ad request, a number of interactions with an object associated with the ad request, and any combination thereof. The advertisement-specific bid adjustment of an ad request is determined 320 so that the influence of the ad request-specific bid adjustment on a bid amount of an ad request decreases as interaction with the ad request increases. For example, the ad request-specific bid adjustment is inversely proportional to a function of a number of impressions associated with the ad request, a function of a number of interactions associated with the ad request, or any combination thereof. In one embodiment, the ad request-specific bid adjustment is inversely proportional to a number of impressions associated with the ad request or to a number of interactions associated with the ad request.

In one embodiment, an advertisement-specific bid adjustment for ad request A (“γ(A)”) is determined 320 as:

γ(A)=1+ε (2),

where ε is a function of a number of impressions associated with ad request A and a number of a specific type, or specific types, of interaction associated with ad request A. For example, c is calculated using the following equation:

$$ε = \frac{{C}_{o}}{\sqrt{clicks ( A )}} + \frac{{D}_{o}}{\sqrt{imps ( A )}} , \qquad ( 3 )$$

where clicks(A) is a number of one or more specific types of interactions with ad request A, imps(A) is a number of impressions of ad request A, and Cₒ and Dₒ are constant values. In this embodiment, an ad request-specific bid adjustment for ad request A is determined 320 as:

$$γ ( A ) = 1 + \frac{{C}_{o}}{\sqrt{clicks ( A )}} + \frac{{D}_{o}}{\sqrt{imps ( A )}} . \qquad ( 4 )$$

The values of constants Cₒ and Dₒ may be determined by the advertiser or by the social networking system 140 so that a number of a specific type of interaction associated with ad request A or a number of impressions associated with ad requests A unequally adjust the ad request-specific bid adjustment. Alternatively, the values of the constants Cₒ and Dₒ are determined so the number or the specific type of interaction associated with an ad request and the number of impressions of the ad request equally influence the ad request-specific bid adjustment for the ad request.

Alternatively, a portion of the ad campaign's budget may be specified by the advertiser for distribution across ad requests in the ad campaign to increase bid amounts associated with various ad requests. In one embodiment, an advertiser specifies a percentage of the budget, and an amount of the budget determined from the percentage is used to determine 320 a bid adjustment for an ad request in the ad campaign or to modify the bid adjustment for the ad request. For example, a percentage of the budget is determined and the percentage of the budget is divided by the number of ad requests in the ad campaign, with a bid adjustment of an ad request increased by the result. Alternatively, a bid amount for the ad request is increased by the result and subsequently modified by the bid adjustment for the ad request.

The social networking system 140 modifies 325 the bid amounts associated with the ad requests eligible for presentation to the user based on the bid adjustments where a bid amount associated with an ad request is modified by a bid adjustment corresponding to the ad request. In various embodiments, a bid adjustment corresponding to an ad request is combined with a bid amount associated with the ad request to modify 325 the bid amount associated with the ad request. For example, a bid adjustment corresponding to an ad request is added to or subtracted from a bid amount associated with the ad request. Alternatively, a bid amount associated with the ad request is scaled by the bid adjustment corresponding to the ad request. As an example, a bid amount of an ad request A is modified 325 by an ad request-specific bid adjustment as follows:

bid(A)=λ·ECTR(A)·CPC·γ(A) (5),

where γ(A) is the advertisement-specific bid adjustment associated with ad request A, ECTR(A) is an expected amount of interaction with the ad request A, CPC is a cost per interaction associated with the ad request A, and λ is a pacing multiplier, as described above.

Modifying 325 a bid amount of an ad request using the ad request-specific bid adjustment allows ad requests having less than a threshold expected amount of user interaction to be included in a selection process for presentation to the user, increasing the likelihood that an ad creative from the ad request is presented to the user. This allows an advertiser to evaluate performance of a greater number of ad request included in the ad campaign, as an ad request-specific bid adjustment may increase a bid amount of an ad request with a low expected amount of user interaction that offsets the low expected amount of user interaction. Additionally, modifying 325 bid amounts using ad request-specific bid adjustments allows the social networking system to reduce bid amounts associated with ad requests eligible for presentation to the user having greater than a threshold expected amount of user interaction to allow presentation of a more diverse selection of ad requests from the ad campaign to the user, as further described above.

Based at least in part on the modified bid amounts, one or more of the ad requests eligible for presentation to the user are selected 330 from the ad campaign. For example, the social networking system 140 ranks the ad requests eligible for presentation to the user based on t their associated modified bid amounts and selects 330 ad requests eligible for presentation to the user having at least a threshold position in the ranking. Alternatively, the social networking system 140 selects 330 ad requests having at least a threshold modified bid amount. The selected one or more ad requests are then included 335 in a selection process that selects content for presentation to the user. For example, the selection process ranks the selected ad requests and ad requests from other ad campaigns based on the bid amounts associated with the ad requests from other ad campaigns and the modified bid amounts associated with the ad requests from the ad campaign and selects ad requests having at least a threshold position in the ranking. Alternatively, a specified number of ad requests associated with bid amounts equaling or exceeding a threshold value are selected for presentation to the user. Ad requests selected by the selection process are communicated to a client device 110 associated with the user for presentation to the user.

If an ad request selected from the ad campaign is selected by the selection process and presented to the user, the social networking system 140 may modify or adjust the bid adjustment associated with the ad request based on the presentation of the ad request, based on an interaction with the ad creative from the ad request by the user, or based on any suitable condition. This allows the social networking system 140 to implement a feedback loop for modifying the bid adjustments so they accurately account for the number of impressions or number of a specific type of interaction with various ad requests over time. In some embodiments, the bid amount or bid adjustment associated with the ad request is decreased if the user does not perform a specific type of interaction or perform an interaction with the ad creative from the ad request after presentation of the ad request. Additionally, the bid adjustment associated with an ad request may be decreased if the user performs an action to hide the ad creative from the ad request from view when it is presented (e.g., hiding the advertisement from view). The social networking system 140 may receive an instruction from an advertiser associated with the ad campaign to cease modifying bid amounts associated with ad requests in the ad campaign. For example, the advertiser communicates an instruction to the social networking system 140 to cease modification of bid amounts associated with ad requests in the ad campaign after one or more ad requests in the ad campaign (e.g., a threshold number of ad requests in the ad campaign) are associated with at least a threshold number of impressions or with at least a threshold number of a certain type of interaction. If modification of the bid amounts of ad requests in the ad campaign is ceased, ad requests are selected from the ad campaign through any one or more conventional methods or through any other suitable method.

In another embodiment, the social networking system 140 identifies an ad request including multiple ad creatives, with different ad creatives associated with different bid amounts, when an opportunity to present an ad request is identified 310. The identified ad request includes ad creatives associated with less than the threshold amount of user interaction. As described above in conjunction with FIG. 3, the social networking system 140 determines 315 a bid amount associated with an ad creative included in the ad request using information for the ad creative similar to information used to determine 315 the bid amount for an ad request as described above in conjunction with FIG. 3. For example, the social networking system 140 determines 315 a bid amount associated with an ad creative included in the ad request based on a pacing multiplier, an expected amount of interaction with the ad creative, and the cost per interaction associated with the ad creative, as described above with respect to an ad request. The social networking system 140 also determines 320 a bid adjustment for the ad creative included in the ad request, as described above in conjunction with FIG. 2, and modifies 325 the bid amount associated with an ad creative using the bid adjustment for the ad creative. Bid amounts and bid adjustments are determined for various ad creatives in the ad request, and the social networking system 140 selects an ad creative for presentation via the ad request based at least in part on the bid amounts for various ad creatives after adjusting the ad creatives based on their corresponding bid adjustments. Hence, modifying bid amounts associated with different ad creatives within an ad request based on bid adjustment values allows the social networking system 140 to modify the ad creatives presented by an ad request, allowing the ad request to present more diverse content.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving an advertisement (“ad”) campaign including a set of advertisement (“ad”) requests, each ad request associated with an ad creative;
identifying an opportunity to present one or more ad requests to a user of a social networking system via a client device;
determining bid amounts associated with each of a plurality of ad requests eligible for presentation to the user from the set of ad requests included in the ad campaign;
determining bid adjustments for each of the plurality of ad requests, each bid adjustment corresponding to an ad request in the plurality of ad requests;
modifying the bid amounts associated with the plurality of ad requests based on the bid adjustments, a bid amount associated with an ad request from the plurality of ad requests modified by a bid adjustment corresponding to the ad request;
selecting one or more ad requests from the plurality of ad requests based at least in part on the modified bid amounts associated with the plurality of ad requests; and
including the selected one or more ad requests from the plurality of ad requests in a selection process that selects content for presentation to the user.

2. The method of claim 1, wherein determining bid adjustments for each of the plurality of ad requests, each bid adjustment corresponding to an ad request in the plurality of ad requests comprises:
determining a number of impressions of the ad request in the plurality of ad requests to users of the social networking system; and
determining a bid adjustment corresponding to the ad request in the plurality of ad requests based at least in part on the determined number of impressions.

3. The method of claim 2, wherein the bid adjustment corresponding to the ad request in the plurality of ad requests is inversely proportional to the determined number of impressions.

4. The method of claim 1, wherein determining bid adjustments for each of the plurality of ad requests, each bid adjustment corresponding to an ad request in the plurality of ad requests comprises:
determining a number of interactions associated with impressions of the ad request in the plurality of ad requests by users of the social networking system presented with the ad request; and
determining a bid adjustment for the ad request in the plurality of ad requests based at least in part on the determined number of interactions.

5. The method of claim 4, wherein the bid adjustment corresponding to the ad request in the plurality of ad requests is inversely proportional to the determined number of interactions.

6. The method of claim 1, wherein determining bid adjustments for each of the plurality of ad requests, each bid adjustment corresponding to an ad request in the plurality of ad requests comprises:
determining a number of interactions associated with impressions of the ad request in the plurality of ad requests by users of the social networking system presented with the ad request;
determining a number of impressions of the ad request in the plurality of ad requests to users of the social networking system; and
determining a bid adjustment for the ad request in the plurality of ad requests based at least in part on the determined number of interactions and the determined number of impressions.

7. The method of claim 6, wherein the bid adjustment corresponding to the ad request in the plurality of ad requests is inversely proportional to the determined number of impressions and to the determined number of interactions.

8. The method of claim 1, wherein determining bid amounts associated with each of the plurality of ad requests eligible for presentation to the user from the set of ad requests included in the ad campaign comprises:
identifying a budget associated with the ad campaign;
identifying an objective associated with the ad campaign, the objective specifying a goal for presenting the set of ad requests in the ad campaign;
determining a time interval associated with the objective; and
determining a bid amount associated with an ad request from the plurality of ad requests based at least in part on the budget, an amount of the objective completed, and the time interval associated with the objective so the objective is completed within the time interval.

9. The method of claim 1, wherein selecting one or more ad requests from the plurality of ad requests based at least in part on the modified bid amounts associated with the plurality of ad requests comprises:
ranking the plurality of ad requests based at least in part on the modified bid amounts; and
selecting one or more ad requests from the plurality of ad requests based at least in part on the ranking.

10. The method of claim 1, wherein selecting one or more ad requests from the plurality of ad requests based at least in part on the modified bid amounts associated with the plurality of ad requests comprises:
selecting one or more ad requests from the plurality of ad requests associated with modified bid amounts equaling or exceeding a threshold value.

11. The method of claim 1, further comprising:
presenting a selected ad request to the user; and
modifying a bid adjustment corresponding to the selected ad request based at least in part on the presentation.

12. The method of claim 1, further comprising:
presenting a selected ad request to the user;
receiving an interaction from the user with an ad creative from the selected ad request; and
modifying a bid adjustment corresponding to the selected ad request based at least in part on the interaction.

13. The method of claim 10, wherein the interaction is selected from a group consisting of: an interaction with the ad creative from the selected ad request, an interaction with an object associated with the selected ad request, and any combination thereof.

14. A computer program product comprising a computer-readable storage medium having instructions encoded thereon that, when executed by a processor, cause the processor to:
receive an advertisement (“ad”) campaign including a set of advertisement (“ad”) requests, each ad request associated with an ad creative;
identify an opportunity to present one or more ad requests to a user of a social networking system via a client device;
determine bid amounts associated with each of a plurality of ad requests eligible for presentation to the user from the set of ad requests included in the ad campaign;
determine bid adjustments for each of the plurality of ad requests, each bid adjustment corresponding to an ad request in the plurality of ad requests;
modify the bid amounts associated with the plurality of ad requests based on the bid adjustments, a bid amount associated with an ad request form the plurality of ad requests modified by a bid adjustment corresponding to the ad request;
select one or more ad requests from the plurality of ad requests based at least in part on the modified bid amounts associated with the plurality of ad requests; and
include the selected one or more ad requests from the plurality of ad requests in a selection process that selects content for presentation to the user.

15. The computer program product of claim 14, wherein determine bid adjustments for each of the plurality of ad requests, each bid adjustment corresponding to an ad request in the plurality of ad requests comprises:
determine a number of impressions of the ad request in the plurality of ad requests to users of the social networking system; and
determine a bid adjustment corresponding to the ad request in the plurality of ad requests based at least in part on the determined number of impressions.

16. The computer program product of claim 15, wherein the bid adjustment corresponding to the ad request in the plurality of ad requests is inversely proportional to the determined number of impressions.

17. The computer program product of claim 14, wherein determine bid adjustments for each of the plurality of ad requests, each bid adjustment corresponding to an ad request in the plurality of ad requests comprises:
determine a number of interactions associated with impressions of the ad request in the plurality of ad requests by users of the social networking system presented with the ad request; and
determine a bid adjustment for the ad request in the plurality of ad requests based at least in part on the determined number of interactions.

18. The computer program product of claim 17, wherein the bid adjustment corresponding to the ad request in the plurality of ad requests is inversely proportional to the determined number of interactions.

19. The computer program product of claim 14, wherein determine bid adjustments for each of the plurality of ad requests, each bid adjustment corresponding to an ad request in the plurality of ad requests comprises:
determine a number of interactions associated with impressions of the ad request in the plurality of ad requests by users of the social networking system presented with the ad request;
determine a number of impressions of the ad request in the plurality of ad requests to users of the social networking system; and
determine a bid adjustment for the ad request in the plurality of ad requests based at least in part on the determined number of interactions and the determined number of impressions.

20. The computer program product of claim 19, wherein the bid adjustment corresponding to the ad request in the plurality of ad requests is inversely proportional to the determined number of impressions and to the determined number of interactions.
